(19) United States
(12) Patent Application Publication
(10) Pub. No.: US 2012/0127703 A1
(43) Pub. Date: May 24, 2012

(54) LAMP HEAD MODULE and LED LAMP

(75) Inventor: WEN-KUEI TSAI, Taipei (TW)

(73) Assignee: TOP ENERGY SAVING SYSTEM CORP., NEW TAIPEI CITY (TW)

(21) Appl. No.: 13/303,034

(22) Filed: Nov. 22, 2011

(30) Foreign Application Priority Data
Nov. 22, 2010 (TW) 099222592

(51) Int. Cl. F21L 4/02; F21L 4/00

(52) U.S. Cl. 362/184; 362/186

(57) ABSTRACT

A lamp head module is disclosed in this invention. The lamp head module includes a lamp head, a cover, and a power module. The cover is disposed on the lamp head, and the power module is enclosed within the inner space of the cover and the lamp head.

### CROSS-REFERENCE TO RELATED APPLICATIONS

The entire contents of Taiwan Patent Application No. 099222592, filed on Nov. 22, 2010, from which this application claims priority, are incorporated herein by reference.

### BACKGROUND OF THE INVENTION

1. Field of the Invention

The present invention generally relates to a lighting device, and more particularly to a lamp head module that is capable of being matched with various housings.

2. Description of Related Art

Due to various advantages of a light-emitting diode (LED) such as small volume, short response time, low power consumption, high reliability and high feasibility of mass production, the LED is replacing conventional lighting devices such as light bulbs or fluorescent lamps.

However, the specifications of LED lamps and housing styles from a variety of manufactures are oftentimes different from each other. It is therefore difficult to construct the LED lamps in modular parts, and the non-modular LED lamps are wastefully accumulated in warehouses. Moreover, when the LED lamp specification or its housing style changes, it is difficult or impossible to reuse constructing parts of the LED lamp by disintegrating the LED lamp.

Accordingly, a need has arisen to propose a modular architecture of LED devices such that the LEDs, the housings and other constructing parts can be matched in use, therefore reducing accumulation in warehouses and improving effective usage.

### SUMMARY OF THE INVENTION

In view of the foregoing, it is an object of the embodiment of the present invention to provide a lamp head module that is capable of being matched with various housings to form a variety of lighting devices.

According to one embodiment, a lamp head module is provided in this invention. The lamp head module includes a lamp head, a cover, and a power module. The cover is disposed on the lamp head, and the power module is enclosed within the inner space of the cover and the lamp head.

According to another embodiment, an LED lamp is provided in this invention. The LED lamp includes a lamp cup, a lamp head module, a convex pedestal, and a plurality of LED elements. The lamp cup includes a main base which is disposed at the upper end of the lamp cup. The lamp head module includes a lamp head, a cover, and a power module. The cover is disposed on the lamp head, and the cover is connected with the lower end of the lamp cup. The power module is enclosed within the inner space of the cover and the lamp head. The convex pedestal is disposed on the main base. The convex pedestal includes a horizontal pedestal and a plurality of tilted pedestals. The horizontal pedestal is disposed at the center of the convex pedestal. These tilted pedestals are disposed between the horizontal pedestal and the main base, wherein the horizontal pedestal is surrounded by these tilted pedestals in a tilted manner. These LED elements are disposed on the horizontal pedestal and the tilted pedestals respectively. These LED elements are capable of projecting liglht along different directions.

### BRIEF DESCRIPTION OF THE DRAWINGS

FIG. 1A and FIG. 1B show the exploded view and the sectional view of a lamp head module in accordance with an embodiment of the present invention;

FIG. 2A shows the sectional view of an LED lamp in accordance with another embodiment of the present invention; and

FIG. 2B and FIG. 2C show the top view and the sectional view of the convex pedestal and the LED elements shown in FIG. 2A.

### DETAILED DESCRIPTION OF THE INVENTION

The detailed description of the present invention will be discussed in the following embodiments, which are not intended to limit the scope of the present invention, and can be adapted for other applications. While drawings are illustrated in detail, it is appreciated that the quantity of the disclosed components may be greater or less than that disclosed, except where expressly restricting the amount of the components.

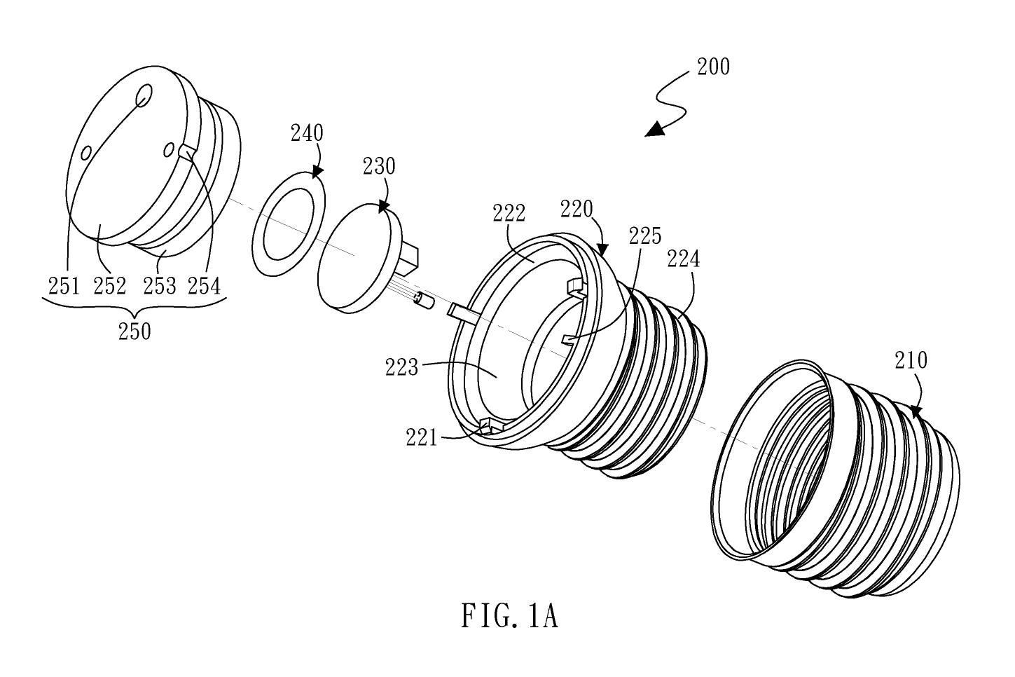

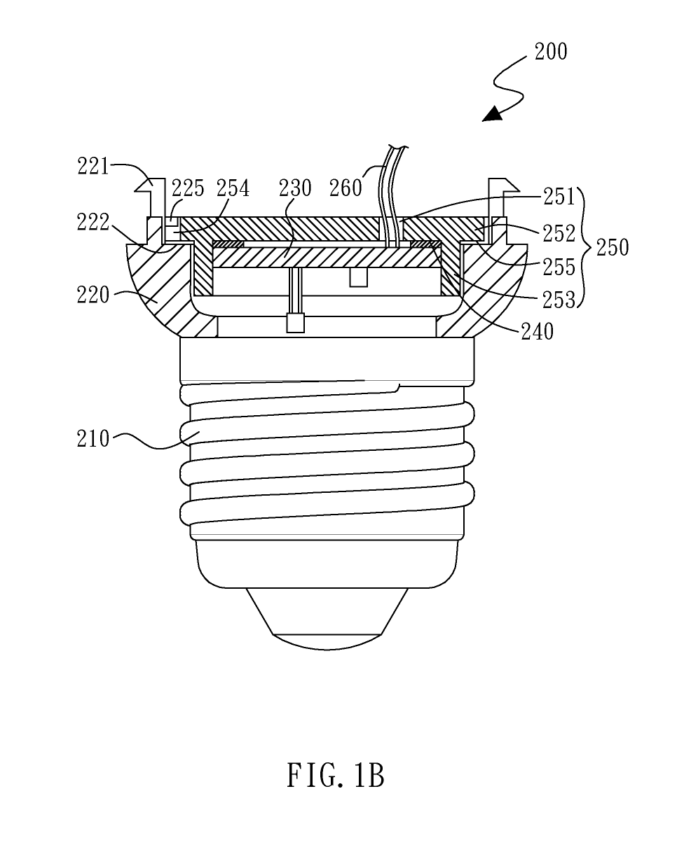

FIG. 1A and FIG. 1B show the exploded view and the sectional view of a lamp head module 200 in accordance with an embodiment of the present invention. The lamp head module 200 includes a lamp head 210, a cover 220, and a power module 230. Wherein one end of the cover 220 is an opening 223, the other end of the cover 220 is an interlocking portion 224. The interlocking portion 224 is interlocked with the lamp head 210 for fixing the cover 220 on the lamp head 210. The power module 230 is enclosed within the inner space of the cover 220 and the lamp head 210. The material of the cover 220 can be plastic, thermal plastic, metal, ceramic or other thermal conduct material.

According to this embodiment, the interlocking portion 224 is a thread screw. The thread screw is screw-jointed with the lamp head 210 for fixing the cover 220 on the lamp head 210. Not limited to this, the interlocking portion 224 can be another design which can interlock the cover 220 with the lamp head 210. In addition, the specification of the lamp head 210 is not limited. The lamp head 210 can be various specifications, such as E26, E27, E11, E14, E40, or B22D.

Moreover, according to this embodiment, the power module 230 is enclosed within the inner space of lamp head module 200, and the power module 230 does not protrude from the cover 220. Not limited to this, the power module 230 can protrude from the cover 220. The power module 230 can include a circuit board and a plurality of electric elements, wherein the power module 230 can include a variable resistance for adjusting the power of the power module 230. The electric elements mentioned above can be disposed on the surface of the circuit board which is toward the lamp head 210. Thus, the electric elements mentioned above can be enclosed within the inner space of lamp head module 200. Not limited to this, the electric elements mentioned above can be disposed on the surface of the circuit board which is far away from the lamp head 210. Thus, the electric elements mentioned above can protrude from the cover 220.

The lamp head module 200 can further include a base 250 and an insulation sheet 240. The base 250 includes a plate 252 and a hollow cylinder 253 extended from a surface of the plate 252. The plate 252 and the hollow cylinder 253 may be manufactured integrally, or may be individually made and then combined. The base 250 may be made of metal (such as copper or silver), ceramic or other heat conductive materials. In this embodiment, the base includes an outer surface 255. The outer surface 255 is used for attaching to an inner surface 222 of the cover 220. Additionally, a side surface of the plate 252 may have one or more notches 254. The notch 254 is used to fasten to a corresponding hook 225 of the cover 220. In the embodiment, the base 250 and the cover 220 can be fixed by screws, glue, or ultrasonic bonding. The space between the base 250 and the cover 220 can be filled with heat conductive glue or heat conductive clay for increasing heat dissipation. The base 250 and the cover 220 can form a sealed space for isolating heat, noise, and moisture.

The insulation sheet 240 is disposed between the power module 230 and the base 250. First, the power module 230 is fixed on the base 250. Then, the base 250 is fixed on the cover 220. The power wire 260 passes the line hole 251 of the base 250 and extends to the outside of the lamp head module 200.

According to this embodiment, the lamp head module 200 can further include a connecting structure 221. The connecting structure 221 is disposed on the cover 220. In this embodiment, the connecting structure 221 includes at least one hook structure. The hook structure is disposed around the opening 223 of the cover 220. The lamp head module 200 can be connected with a lamp cup by the hook structure. However, the connecting structure 221 is not limited. In another embodiment, the connecting structure 221 can include a thread screw. Thus, the lamp head module 200 can be screw-jointed with the lamp cup by the thread screw (not shown).

According to the present embodiment, the constructing parts of the lamp head module 200 are assembled and tested to build a half-finished product, which may be later matched with other parts (such as the lampshade, the light module or the housing) to form various lighting devices, such as an LED lamp or a spot light. Accordingly, the accumulation in the warehouse may be substantially reduced.

By the lamp head module of the present invention, the lamp head module can be disassembled from an LED lamp or be assembled with the lamp cup of another LED lamp easily. Thus, the constructing parts of the LED lamp can be exchanged or reused. It is not only easy to produce, but also reduces the accumulation in the warehouse and achieves effective use of the resources. Moreover, because the power module is enclosed within the inner space of lamp head module, there is a sufficient heat dissipating space between the power module and the LED chips. The electric circuit is far away from the heat source for achieving stable operation and longer life.

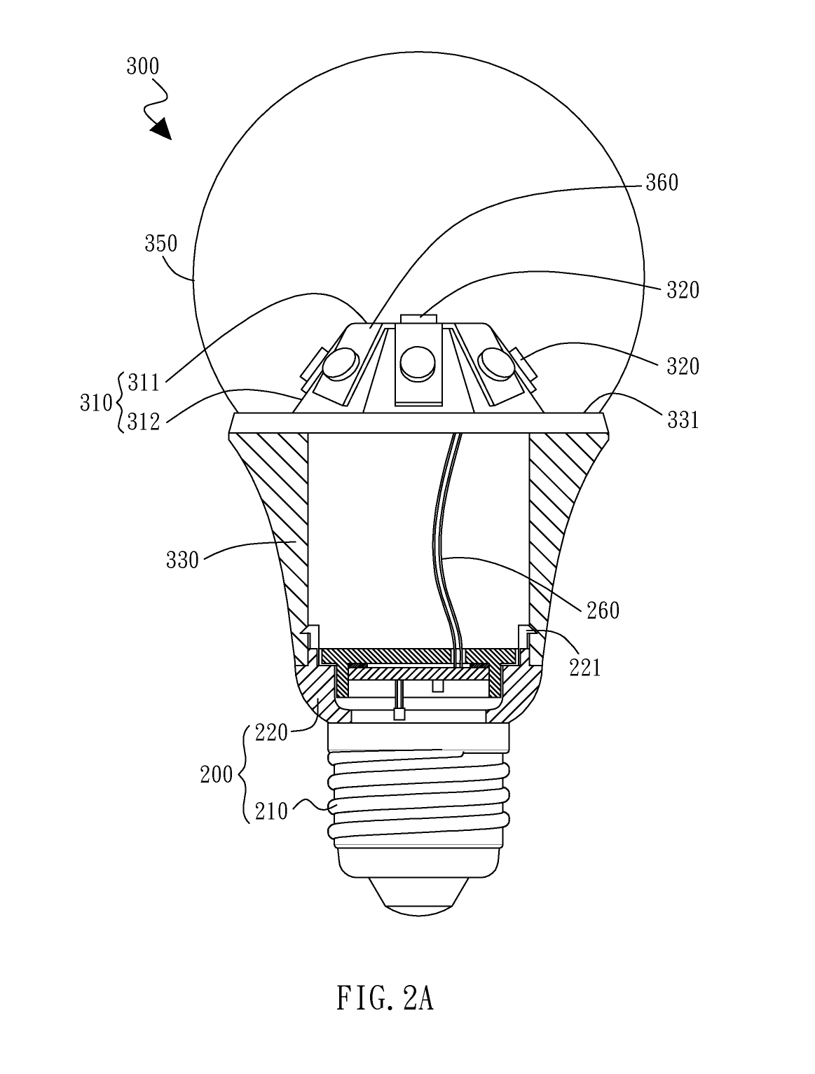

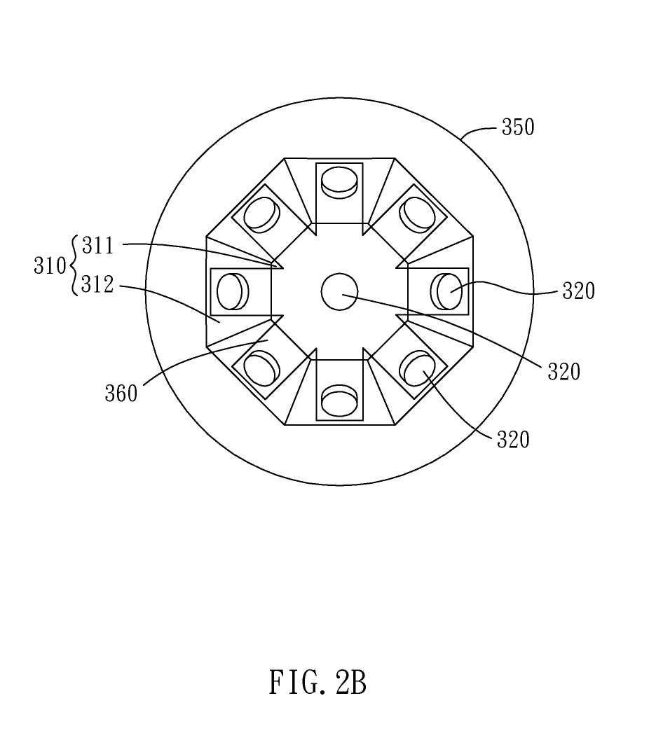

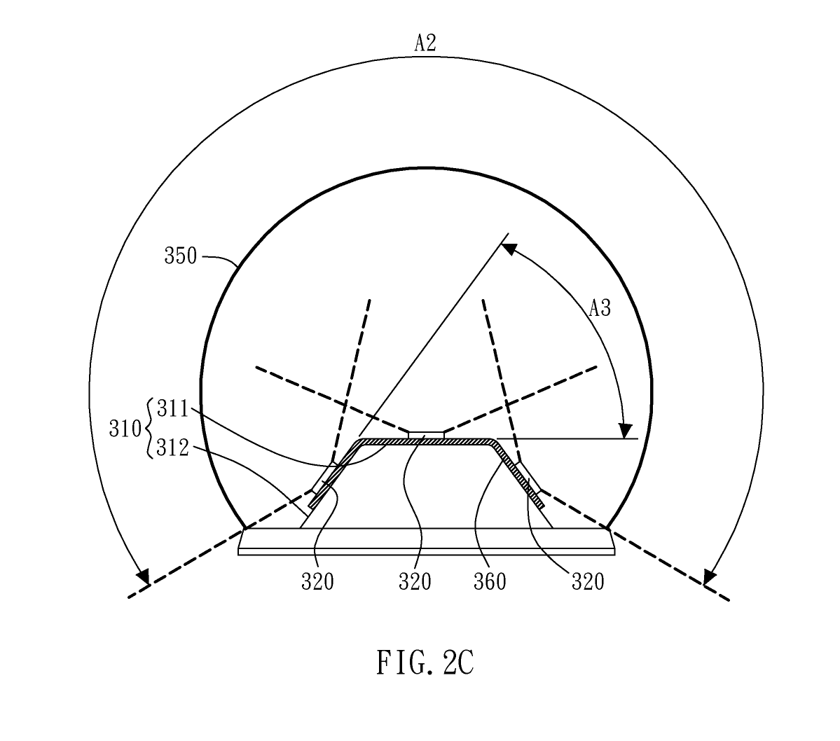

FIG. 2A shows the sectional view of an LED lamp 300 in accordance with another embodiment of the present invention. The LED lamp 300 includes a convex pedestal 310, a plurality of LED elements 320, a lampshade 350, a lamp cup 330, and a lamp head module 200.

The related description of the lamp head module 200 has been mentioned above, and the same description of the lamp head module 200 will not be repeated here. In this embodiment, the connecting structure 221 of the lamp head module 200 is capable of connecting the cover 220 with the lamp cup 330.

The convex pedestal 310 is disposed at the upper end of the lamp cup 330. There is a main base 331 between the lamp cup 330 and lampshade 350. The convex pedestal 310 is formed on the main base 331. The upper portion of the convex pedestal 310 is narrower than the lower portion of the convex pedestal 310. The convex pedestal 310 includes a horizontal pedestal 311 and a plurality of tilted pedestals 312. The horizontal pedestal 311 is disposed at the center of the convex pedestal 310. These tilted pedestals 312 are disposed between the horizontal pedestal 311 and the main base 331, wherein the horizontal pedestal 311 is surrounded by these tilted pedestals 312 in a tilted manner. Furthermore, the lampshade 350 is made of light penetrating material. The lampshade 350 can be treated by the surface roughing treatment. Thus, the lampshade 350 is able to convert the light projected by LED elements 320 to diffuse light so as to soften the light and reduce glare.

FIG. 2B and FIG. 2C show the top view and the sectional view of the convex pedestal 310 and the LED elements 320 shown in FIG. 2A. In this embodiment, the LED elements 320 are disposed on the horizontal pedestal 311 and the tilted pedestals 312 respectively. A control circuit 360 is laid on the horizontal pedestal 311 and the tilted pedestals 312, and the LED elements 320 are disposed on the control circuit 360. The control circuit 360 can be made of a flexible circuit board, an aluminum substrate, or a ceramic substrate. Not limited to this, the control circuit 360 can be disposed on other positions. For example, the control circuit 360 can be disposed under the convex pedestal 310 or the main base 331. Also, the control circuit 360 can be connected with the LED elements 320 by wires.

There is a tilt angle A3 between the horizontal pedestal 311 and the tilted pedestals 312. In this embodiment, the tilt angle A3 is 10 to 80 degrees. The tilt angle A3 is preferred to be 30 to 60 degrees, but not limited to this embodiment. Whereby, the LED elements 320 disposed on the horizontal pedestal 311 are capable of projecting light toward the top of the horizontal pedestal 311; the LED elements 320 disposed on the tilted pedestals 312 are capable of projecting light along tilted directions. These LED elements 320 mentioned above are capable of projecting light along different directions so as to make these LED elements 320 project light at the best angles. Thus, the LED lamp 300 can have a wider projecting area A2 which has uniform illumination. Thereby, in this embodiment, the illumination under the horizontal pedestal 311 is increased to 15% of the total illumination.

Moreover, according to this embodiment, the convex pedestal 310 includes a plurality of tilted pedestals 312. For example, the convex pedestal 310 can include 6 or 8 tilted pedestals 312. The number of the convex pedestal 310 and the tilt angle A3 can be designed according to the real condition. For example, the number of the convex pedestal 310 and the tilt angle A3 can be designed according to the number of the LED elements 320, the projecting angle, and the illumination distribution.

The LED lamp of the present invention includes a plurality of LED elements. These LED elements are disposed on the horizontal pedestal and the tilted pedestals respectively so as to make these LED elements project light at the best angles. Thus, the LED lamp can have a wider projecting area which has uniform illumination.

Although specific embodiments have been illustrated and described, it will be appreciated by those skilled in the art that various modifications may be made without departing from the scope of the present invention, which is intended to be limited solely by the appended claims.

What is claimed is:

1. A lamp head module, comprising:
a lamp head;
a cover, wherein one end of said cover is an opening, the other end of said cover is an interlocking portion, said interlocking portion is interlocked with said lamp head for fixing said cover on said lamp head; and
a power module, wherein said power module is enclosed within the inner space of said cover and said lamp head.

2. The lamp head module according to claim, wherein said interlocking portion is a thread screw.

3. The lamp head module according to claim 1, wherein said power module protrudes from said cover.

4. The lamp head module according to claim 1, wherein said power module comprises a variable resistance for adjusting the power of said power module.

5. The lamp head module according to claim 1, further comprising a connecting structure, wherein said connecting structure is connected with a lamp cup.

6. The lamp head module according to claim 5, wherein said connecting structure comprises at least one hook structure, said lamp head module is connected with said lamp cup by said hook structure.

7. The lamp head module according to claim 1, further comprising a base, wherein said base comprises an outer surface, said outer surface is attached to an inner surface of said cover for disposing said base on said cover.

8. The lamp head module according to claim 7, further comprising an insulation sheet, wherein said insulation sheet is disposed between said power module and said base.

9. The lamp head module according to claim 1, wherein the material of said cover is a thermal plastic.

10. An LED lamp, comprising:
a lamp head module, said lamp head module comprising a lamp head, a cover, and a power module, wherein one end of said cover is an opening, the other end of said cover is an interlocking portion, said interlocking portion is interlocked with said lamp head for fixing said cover on said lamp head, said power module is enclosed within the inner space of said cover and said lamp head;
a lamp cup, said lamp cup comprising a main base being disposed at the upper end of said lamp cup, said cover of said lamp head module is connected with the lower end of said lamp cup;
a convex pedestal, wherein said convex pedestal is formed on said main base, said convex pedestal comprises a horizontal pedestal and a plurality of tilted pedestals, said horizontal pedestal is disposed at the center of said convex pedestal, said tilted pedestals are disposed between said horizontal pedestal and said main base, said horizontal pedestal is surrounded by said tilted pedestals in a tilted manner;
a plurality of LED elements, wherein said LED elements are disposed on said horizontal pedestal and said tilted pedestals respectively, said LED elements are capable of projecting light along different directions; and
a lampshade, wherein said lampshade is disposed on the upper end of said lamp cup.

11. The LED lamp according to claim 10, further comprising a control circuit, wherein said control circuit is laid on said convex pedestal, said LED elements are disposed on said control circuit.

12. The LED lamp according to claim 11, wherein said control circuit comprises a flexible circuit board, an Aluminum substrate, or a ceramic substrate.
